(19) United States
(12) Patent Application Publication
(10) Pub. No.: US 2003/0080562 A1
(43) Pub. Date: May 1, 2003

(54) Micro fluidic interconnect port system

(76) Inventors: Michael L. Bailey, Oak Harbor, WA (US); Thomas C. Dykas, Bellingham, WA (US)

Correspondence Address: Steven R. Borgman, 2300 First City Tower, 1001 Fannin, Houston, TX, 77002-6760, US

(21) Appl. No.: 10/154,860

(22) Filed: May 24, 2002

Related U.S. Application Data
(60) Provisional application No. 60/293,632, filed on May 25, 2001.

(51) Int. Cl. F16L 17/00

(52) U.S. Cl. 285/346

(57) ABSTRACT

A leak-free, biocompatible connection assembly for lab-on-a-chip applications is provided. In one embodiment, a tube is located through a nut, through at least one ferrule of an inert material, and through a port. The port is attached to the “lab chip” so that the end of the tube is in fluid communication with a reservoir or channel in the chip. In another embodiment, a multiport manifold is used to connect a plurality of tubes to the lab chip.

### CROSS-REFERENCE TO RELATED APPLICATIONS

This application claims priority to U.S. provisional patent application serial No. 60/293,632, filed May 25, 2001.

### FIELD OF INVENTION

This invention relates to fluidic connections useful in liquid chromatography and other analytical methods. More specifically, this invention relates to connections useful in applications with lab on a chip technologies.

### BACKGROUND

As sample sizes get smaller, and the requirements for accuracy and precision get more demanding in analytic chemistry, the amount of dead volume in the chromatographic or other system becomes more of a concern. Various approaches have been developed to address this concern.

One approach involves the use of “lab on a chip” applications. However, the fluidic connections with such applications are of concern. Conventional approaches have not worked due to a variety of issues, including the high pressures at which the equipment much perform, the chemical corrosivity of solvents used in some applications, and the like.

### SUMMARY OF THE INVENTION

The present invention solves problems with fluidic connections in lab on a chip applications by providing a leak-free, biocompatible connection assemble for lab on a chip applications. In one embodiment of the invention, a tube is located through a nut, through at least one ferrule of an inert material, and through a port. The port is attached to the “lab chip” so that the end of the tube is in fluid communication with a reservoir or channel in the chip. In another embodiment of the invention, a multiport manifold is used to connection a plurality of tubes to the lab chip.

### DESCRIPTION OF THE DRAWINGS

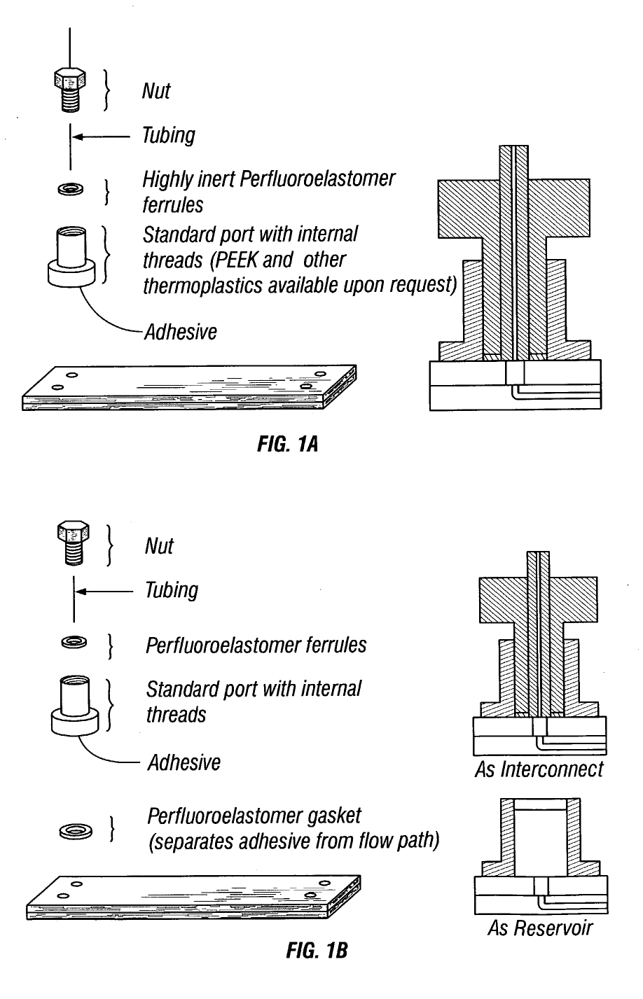

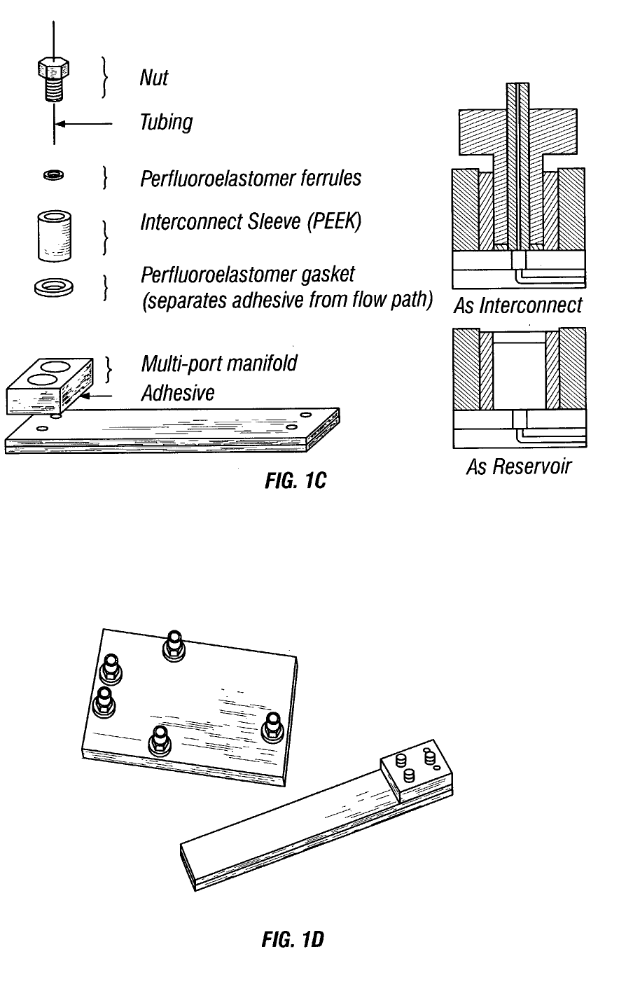

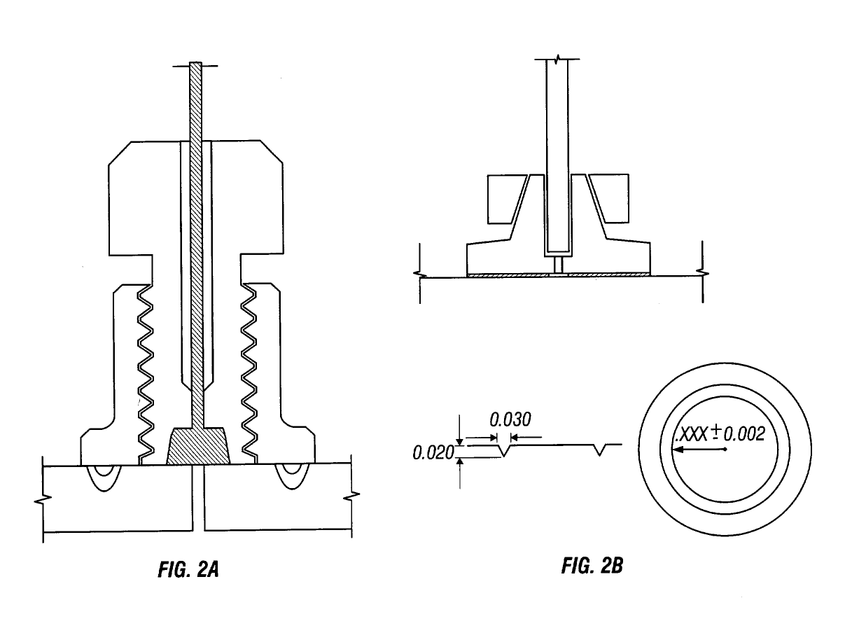

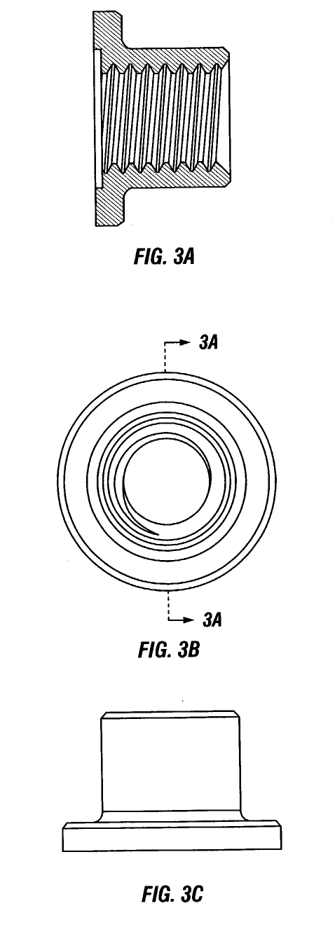

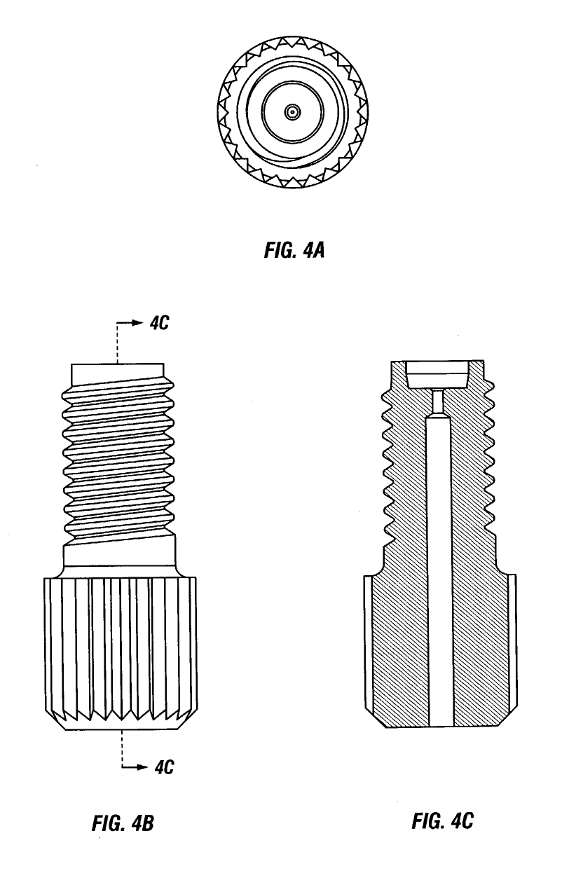

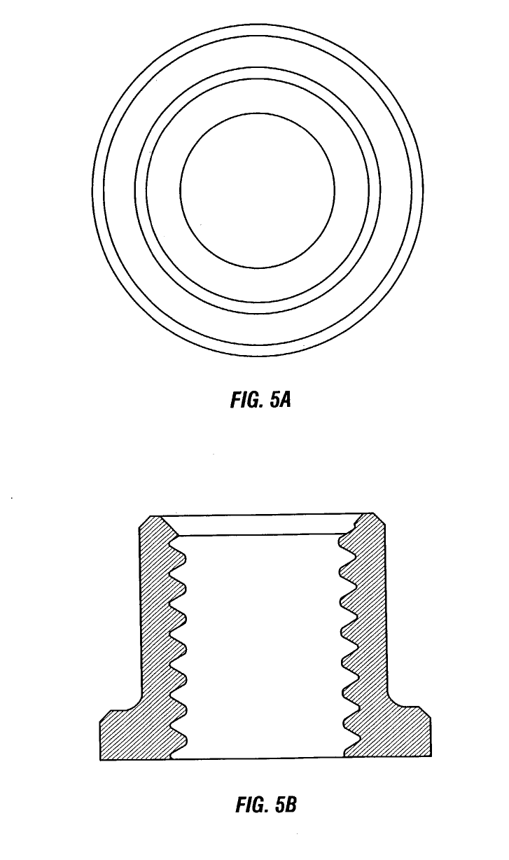

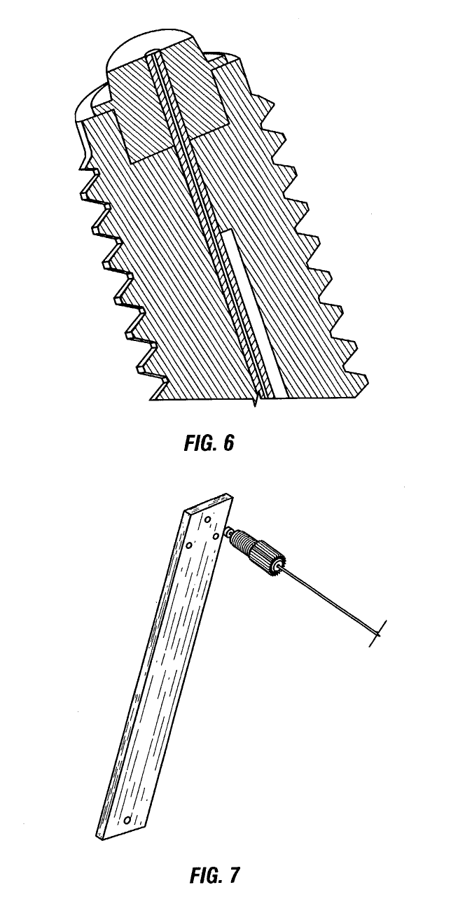

Attached are a series of drawings (FIGS. 1A, 1B, 1C, 1D, 2A, 2B, 3A, 3B, 3C, 4A, 4B, 4C, 5A, 5B, 6 and 7) in exploded views and cross sectional views which show the present invention.

### DETAILED DESCRIPTION OF THE PREFERRED EMBODIMENT

The seven (7) pages attached hereto describe the present invention in detail. These pages are incorporated by reference herein.

We claim:

1. A connection assembly as shown and described in the specification for the application identified above.
